(19) United States
(12) Patent Application Publication
(10) Pub. No.: US 2023/0415355 A1
(43) Pub. Date: Dec. 28, 2023

(54) LINKAGE MECHANISM, ROBOTIC FINGER AND ROBOT

(71) Applicant: UBTECH ROBOTICS CORP LTD., Shenzhen (CN)

(72) Inventors: ZHONGKUI HUANG, Shenzhen (CN); Hongyu Ding, Shenzhen (CN); Xixiang Luo, Shenzhen (CN); Ming Chen, Shenzhen (CN); Wenhua Fan, Shenzhen (CN)

(21) Appl. No.: 18/243,669

(22) Filed: Sep. 8, 2023

Related U.S. Application Data
(63) Continuation of application No. PCT/CN2021/124614, filed on Oct. 19, 2021.

(30) Foreign Application Priority Data
Mar. 10, 2021 (CN) 2021-10261846.0

(51) Int. Cl. B25J 15/00; B25J 15/02

(52) U.S. Cl. CPC B25J 15/0009; B25J 15/022

(57) ABSTRACT

A linkage mechanism includes: a base member; a first link having a first end rotatably connected to the base member; a second link rotatably connected to the first link; a connecting member rotatably connected to the base member and the second link; an actuating mechanism having a linear actuator, a pushing member, and a transmission member, the pushing member slidably connected to the output shaft, the pushing member having a pushing surface, the transmission member including a first end hinged to the pushing member, and a second end pivoted to the first end of the first link. When the output shaft extends to push the pushing surface, the pushing member moves and the first link rotates relative to the base member.

### CROSS REFERENCE TO RELATED APPLICATIONS

The present application is a continuation-application of International Application PCT/CN2021/124614, with an international filing date of Oct. 19, 2021, which claims foreign priority to Chinese Patent Application No. 202110261846.0, filed on Mar. 10, 2021 in the China National Intellectual Property Administration, the contents of all of which are hereby incorporated by reference in its entirety.

### TECHNICAL FIELD

The present disclosure generally relates to robotic fingers, and particularly to a linkage mechanism, robotic finger, and robot.

### BACKGROUND

One commonly used transmission mechanism for robotic fingers is a linkage mechanism, which is generally a four-bar mechanism with a single degree of freedom. That is, an actuator drives the linkage mechanism to move in a fixed path to realize the flexion and extension of a robotic finger. As a moving mechanism, some conventional four-bar mechanisms may tend to be damaged by the external force from collision and impact. When the four-bar mechanisms are subjected to external force, it cannot passively bend and move, and the movement appears stiff and not smooth.

Therefore, there is a need to provide a linkage mechanism to overcome the above-mentioned problem.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of a linkage mechanism in an extension state according to one embodiment.

FIG. 2 is another isometric view of the linkage mechanism in an extension state according to one embodiment.

FIG. 3 is an isometric exploded view of the linkage mechanism.

FIG. 4 is another isometric exploded view of the linkage mechanism.

FIG. 5 is a planar exploded view of the linkage mechanism.

FIG. 6 is another planar exploded view of the linkage mechanism.

FIG. 7 is an isometric exploded view of the linkage mechanism.

FIG. 8 is an isometric view of the linkage mechanism in a passive flexion state.

FIG. 9 is an isometric view of the linkage mechanism in an active flexion state.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

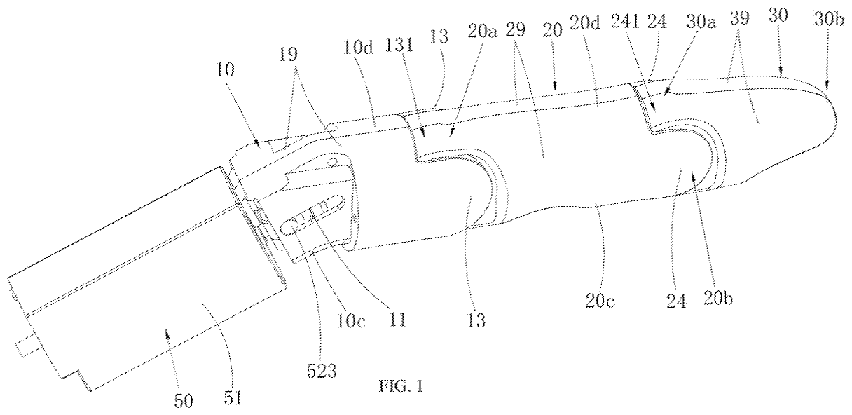

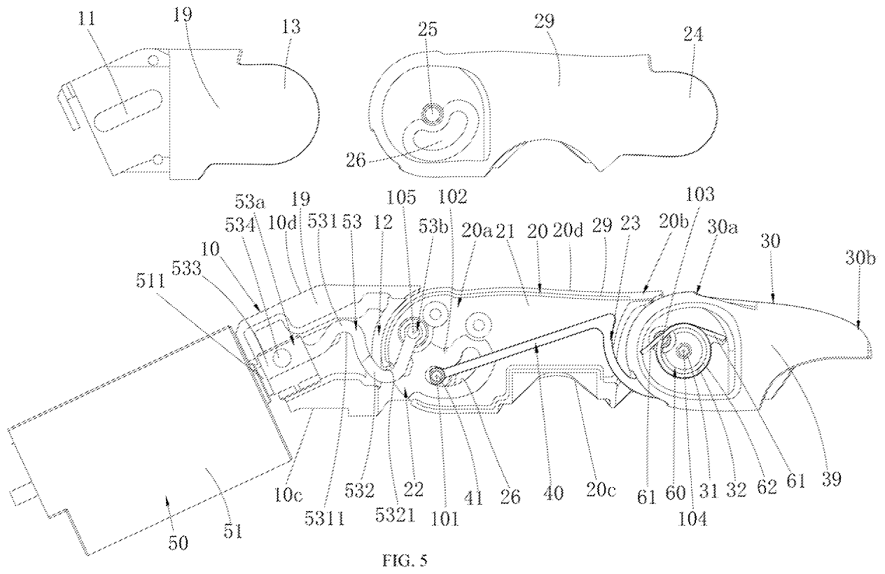

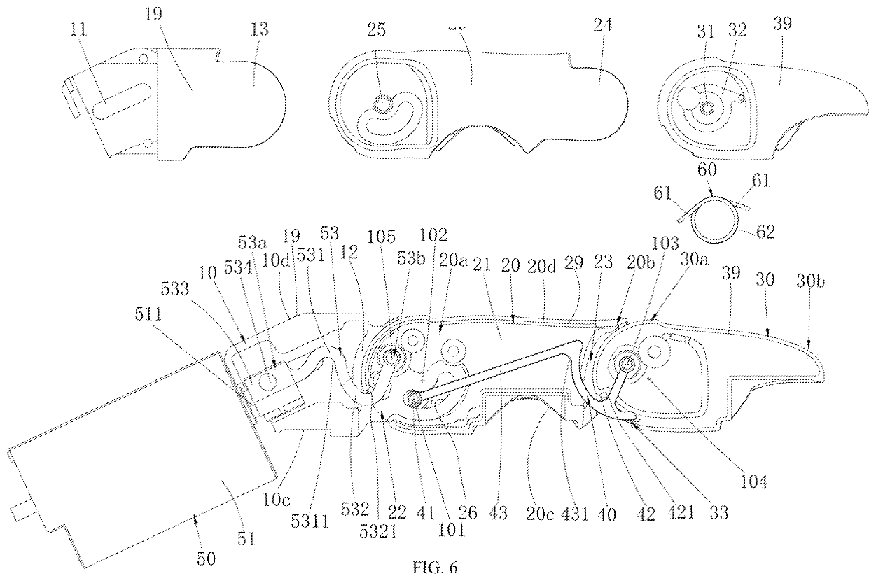

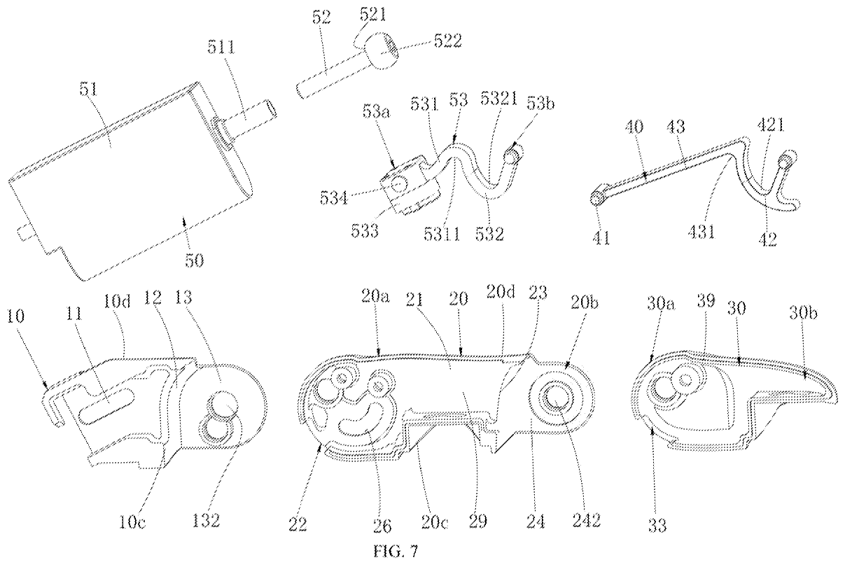

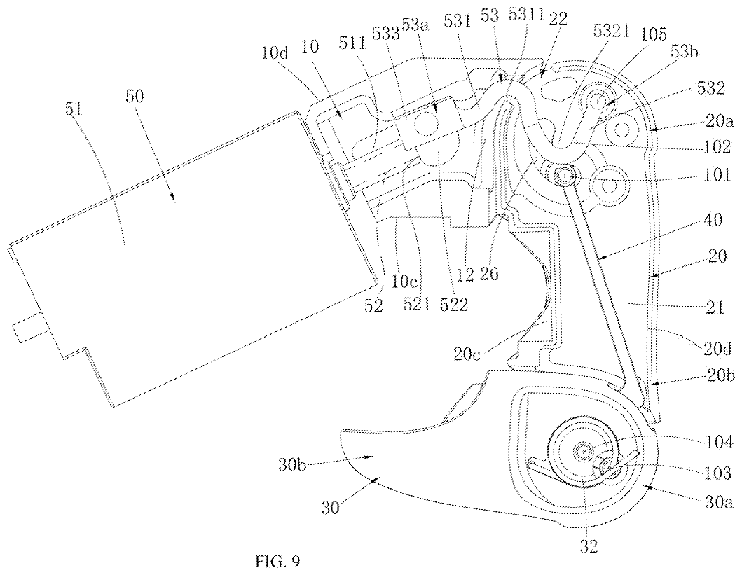

Referring to FIGS. 1-4, in one embodiment, a linkage mechanism a base member 10, a first link 20, a second link 30, a connecting member 40, an actuating mechanism 50, and an elastic member 60. The first end 20a of the first link 20 is pivotally connected to the base member 10. The second link 30 is pivotally connected to the second end 20b of the first link 20. Two opposite ends of the connecting member 40 are pivotally connected to the base member 10 and the second link 30, respectively. Referring to FIGS. 5 and 6, the pivot axis 101 about which the connecting member 40 rotates relative to the base member 10 and the pivot axis 102 about which the first link 20 rotates relative to the base member 10 are spaced apart from each other. The pivot axis 103 about which the connecting member 40 rotates relative to the second link 30 and the pivot axis 104 about which the first link 20 rotates relative to the second link 30 are spaced apart from each other. Referring to FIGS. 6 and 7, the actuating mechanism 50 includes a linear actuator 51 having an output shaft 511, a pushing member 52 and a transmission member 53. The pushing member 52 is slidably connected to and slidable along the output shaft 511. That is, the pushing member 52 can slide along a lengthwise direction of the output shaft 511. The pushing member 52 has a pushing surface 521 that is pushed by the output shaft 511. The first end 53a of the transmission member 53 is hinged to the pushing member 52, and the second end 53b of the transmission member 53 is rotatably connected to the first end 20a of the first link 20. The pivot axis 105 about which the transmission member 53 rotates relative to the first link 20 and the pivot axis 102 about which the first link 20 rotates relative to the base member 10 are spaced apart from each other. Referring to FIGS. 5 and 6, the two opposite ends of the elastic member 60 are respectively connected to the first link 20 and the second link 30. The elastic member 60 is to automatically return the second link 30 to its original position. Referring to FIGS. 7 and 9, when the output shaft 511 extends and moves to push the pushing surface 521, the push rod 52 extends and moves and the first link 20 swings relative to the base member 10.

Compared with some conventional link mechanisms, the base member 10, the first link 20, the second link 30 and the connecting member 40 constitute a four-bar mechanism. Active flexion, extension and passive flexion motions of the four-bar mechanism can be realized by the four-bar mechanism together with the actuating mechanism 50 and the elastic member 60. Referring to FIG. 9, the flexion state of the four-bar mechanism means that a predetermined angle is formed between the first link 20 and the base member 10, a predetermined angle is formed between the second link 30 and the first link 20, and the base member 10, the first link 20 and the second link 30 form a shape similar to a hook. Referring to FIGS. 1 and 6, the extension state of the four-bar mechanism is a state in which the base member 10, the first link 20, and the second link 30 extend substantially along a straight line.

Referring to FIGS. 7 and 9, when the output shaft 511 of the linear actuator 51 extends and moves, the first output shaft 511 will push the pushing surface 521 of the pushing member 52 to drive the pushing member 52 to extend and move. The transmission member 53 is then pushed to move, causing the first link 20 to swing relative to the base member 10. The second link 30 rotates as the connecting member 40 moves. The second link 30 swings following the swing direction of the first link 20. The elastic member 60 is compressed/twisted and stores energy. Active flexion motion is thus realized. When the output shaft 511 retracts, the elastic member 60 rebounds/unwinds and drives the second link 30 to return to its original position. The first link 20, the connecting member 40, the transmission member 53 and the pushing member 52 rotate together to realize the extension motion.

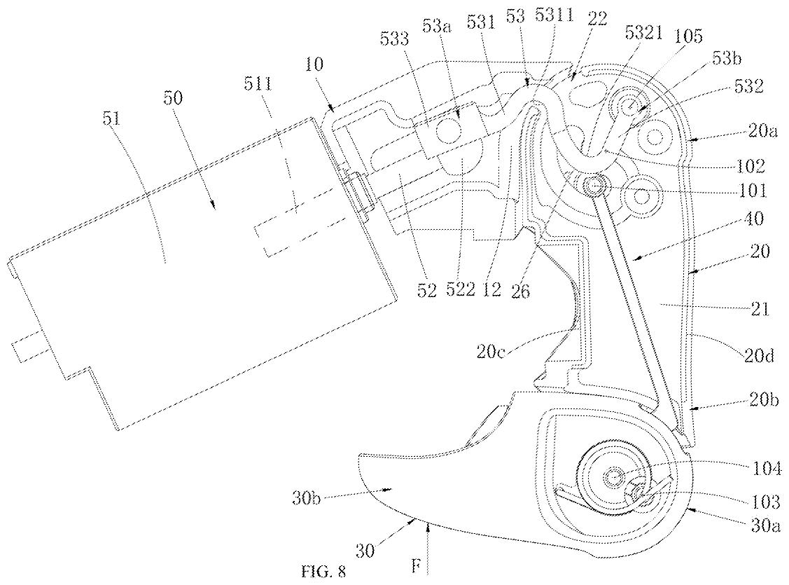

Referring to FIG. 8, regardless of whether the linear actuator 51 is in operation or not, when the second link 30 is subjected to an external force F, the second link 30 can swing and the elastic member is compressed or twisted and stores energy. The first link 20 rotates together with the connecting member 40, and the first link 20 swings following the swing direction of the second link 30. Passive flexion motion is thus realized. Since the pushing member 52 is slidably connected to the output shaft 511, during the passive flexion motion, there will be no interference between the first link 20 and the transmission member 53, which avoids the damage of the four-bar mechanism due to external force and plays a role of impact protection. Referring to FIG. 5, after the external force is removed, the elastic member 60 rebounds/unwinds to drive the second link 30 to rotate to its original position, and first link 20, the connecting member 40, the transmission member 53 and the pushing member 52 rotate together to realize the extension motion.

The linkage mechanism has a certain degree of passiveness, that is, it can move passively under the action of an external force, avoiding rigid collisions, and has a certain degree of flexibility. Each connection position in the linkage mechanism is a precision constraint, so the linkage mechanism has better motion precision. The linkage mechanism has good imitation properties when applied to robot fingers, and the linkage mechanism can be applied to other scenarios that require two-way active movement and one-way passive movement.

Exemplarily, referring to FIG. 5, the linear actuator 51 may be an electric cylinder, which can output a predetermined displacement to push the pushing member 52 and the transmission member 53 to move forward so as to drive the first link to swing relative to the base member 10, and cause the pushing member 52 and the transmission member 53 to return to their original positions, which, combined with the elastic member 60, can realize the flexion and extension motions of the four-bar mechanism. The linear actuator 51 can be mounted on the base member 10.

Exemplarily, referring to FIG. 5, the base member 10, the first link 20, the second link 30, and the connecting member 40 form a double rocker mechanism, with the first link 20 and the connecting member 40 being rockers. The connecting member 40 and the first link 20 are respectively pivotally connected to the first end 30a of the second link 30 at positions spaced apart from each other, and the second end 30b of the second link 30 is a free end. The four-bar mechanism has an extension state and a flexion state, and is movable between the extension and flexion states

In the process of flexing and extending of the four-bar mechanism, the first link 20 and the connecting member 40 function as rockers, and the line passing through the two pivot points of the first link 20 (i.e., the line passing through the points formed by axes 102 and 104 in FIG. 5) and the line passing through the two pivot points of the connecting member 40 (i.e., the line passing through the points formed by axes 101 and 103 in FIG. 5) intersect with each other, which can realize the overall flexion and extension of the four-bar mechanism. That is, the actuating mechanism 50 can drive the first link 20 to swing, and the second link 30 can swing following the swing direction of the first link 20.

Referring to FIG. 5, when the four-bar mechanism is in an extension state, the structural components such as the base member 10, the first link 20 and the second link 30 are flush with one another. Being flush can mean that the structural components are connected in the same straight line, or there is a small angle between the extending directions of the structural components, such as 5°, which is not specifically limited. Referring to FIG. 9, when the four-bar mechanism is fully flexed, the base member 10 is perpendicular to the first link 20, and the first link 20 is perpendicular to the second link 30.

When the linkage mechanism is applied to a robot finger, the base member 10 can function as a proximal phalanx, the first link 20 can function as a middle phalanx, and the second link 30 can function as a distal phalanx. The robot finger can realize active flexing, extending and passive flexing motions, and has good abilities to imitate a finger of a human.

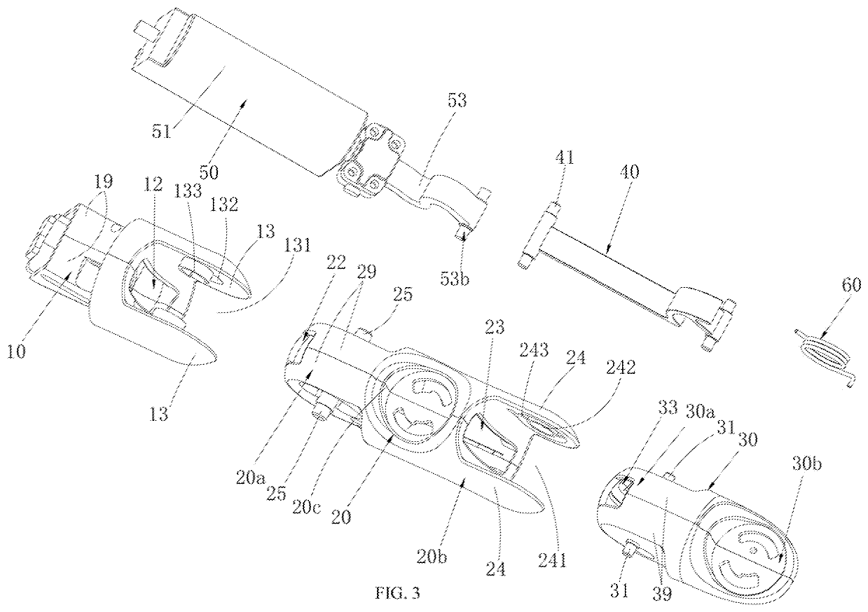

Exemplarily, referring to FIGS. 3 to 5, the base member 10 includes two fixing sub-shells 19 connected to each other, so as to at least partially accommodate the actuating mechanism 50 inside the base member 10. The first link 20 includes two first sub-shells 29 connected to each other, which allows a portion of the connecting member 40 to be received inside the first link 20. The second link 30 includes two second sub-housings 39 connected to each other, which allows a portion of the connecting member 40 to be received inside the first link 20. With such configuration, the base member 10, the first link 20 and the second link 30 can form a better finger appearance (as shown in FIGS. 1 and. 2).

Referring to FIG. 3, in one embodiment, a first opening 12 is defined at one end of the base member 10 close to the first link 20, and the transmission member 53 is partly located in the base member 10. The second end 53b of the transmission member 53 passes through the first opening 12. This can better protect the transmission member 53, and prevent the transmission member 53 from being exposed to the outside of the base member 10, thereby obtaining a finger-like appearance. One end of the second link 30 close to the first link 20 defines a second opening 33, and one end of the connecting member 40 passes through the second opening 33. This can better protect the connecting member 40, and prevent the connecting member 40 from being exposed to the outside of the second link 30, thereby obtaining a finger-like appearance.

Referring to FIG. 7, in one embodiment, the output shaft 511 is hollow, and the pushing member 52 is slidably received in the output shaft 511. One end of the pushing member 52 has a head 522, and the pushing surface 521 is formed on the head 522. The outer diameter of the head 522 is greater than the outer diameter of the shank of the pushing member 52, and the pushing surface 521 is formed on the ring region of the head 522 that faces the shank. When assembling, the shank of the pushing member 52 is inserted into the inner hole of the output shaft 511, and one end surface of the output shaft 511 abut against the pushing surface 521. This structure is easy to assemble. Referring to FIG. 9, when the output shaft 511 extends and moves, the pushing surface 521 of the pushing member 52 is pushed, causing the pushing member 52 to extend and move. When the output shaft 511 retracts and moves, the pushing member 52 can move back to its initial state by the elastic member 60. A cylindrical pair can be used for the output shaft 511 and the pushing member 52, which has the characteristics of high machining accuracy and stable motion performance, and can maintain high motion accuracy.

In another embodiment, the pushing member 52 is hollow and arranged around the output shaft 511 and the pushing member 52 is slidable with respect to the output shaft 511. One end of the pushing member 52 has a head, and the pushing surface 521 is formed on the head. In this case, the pushing surface 521 is the inner end surface of the pushing member 52. When assembling, the output shaft is inserted into the inner hole of the pushing member, and one end surface of the output shaft abuts against the pushing surface of the pushing member. This structure is easy to assemble. When the output shaft extends and moves, the pushing surface of the pushing member is pushed, causing the pushing member to extend and move. When the output shaft retracts and moves, the pushing member can move back to its initial state by the elastic member. A cylindrical pair can be used for the output shaft 511 and the pushing member 52, which has the characteristics of high machining accuracy and stable motion performance, and can maintain high motion accuracy.

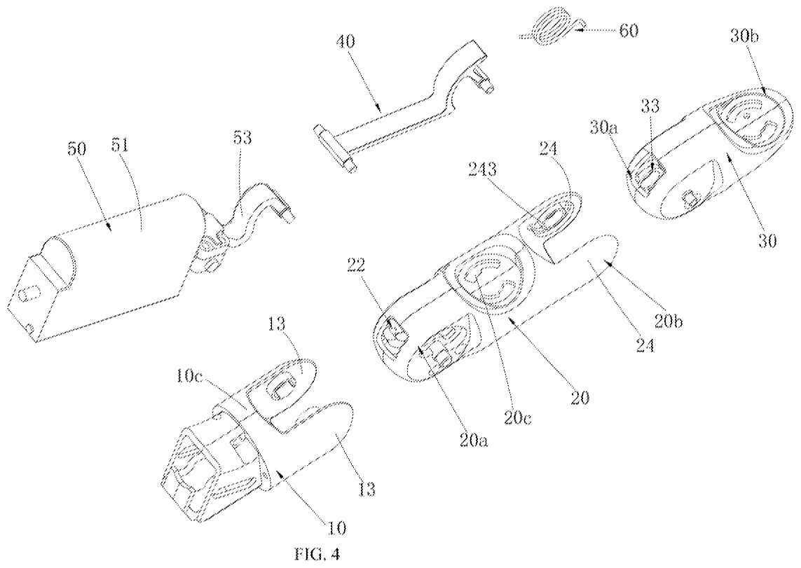

Referring to FIGS. 4 and 5, in one embodiment, the first link 20 defines a chamber 21, and the first end 20a of the first link 20 defines a first opening 22 communicating with the chamber 21. The transmission member 53 passes through the first opening 22. Referring to FIGS. 3 and 6, the second end 20b of the first link 20 is provided with a second opening 23 communicating with the chamber 21. At least a portion of the connecting member 40 is received in the first link 20. The connecting member 40 passes through the second opening 23. A portion of the connecting member 40 is disposed inside the first link 20 to better protect the connecting member 40 and prevent the connecting member 40 from being exposed outside the first link 2, thereby obtaining a finger-like appearance.

Referring to FIGS. 6 and 7, in one embodiment, the transmission member 53 includes a first bent portion 531, and the concave side 5311 of the first bent portion 531 faces the outer side of the base member 10. One end of the first bent portion 531 is pivotally connected to the first link 20. The transmission member 53 further includes a second bent portion 532 connected to one end of the first bent portion 531, and the concave side 5321 of the second bent portion 532 faces the inner side of the base member 10. One end of the second bent portion 532 is securely connected to the output shaft of the linear actuator 51. The bent portions can be understood as bent structures with concave sides formed by bending rods. The bent portions are roughly 7-shaped, and the specific shaping method is not limited. The inner side 10c and the outer side 10d of the base member 10 are respectively the inner side 10c and the outer side 10d of the base member 10 when the four-bar mechanism is in a flexion motion. The transmission member 53 is formed to include the first bent portion 531 and the second bent portion 532. The concave side 5311 of the first bent portion 53 and the concave side 5321 of the second bent portion 532 face different directions. The first bent portion 531 and the second bent portion 532 are approximately in a single-cycle sinusoidal structure, which can improve the elasticity of the transmission member 53 to absorb the external impact, and allow the first link 20 to immediately return to the original state when the external impact disappears.

Referring to FIG. 7, in one embodiment, the output shaft 511 is detachably connected to the pushing member 52. In this way, rapid switching between passive flexion enabled mode and passive flexion disabled mode can be performed without structural modification. When it is desired that the linkage mechanism cannot be passively flexed, the output shaft 511 and the pushing member 52 can be fixedly connected to each other. When it is desired that the linkage mechanism can be flexed passively, the output shaft 511 and the pushing member 52 can be disassembled from each other. The detachable connection between the output shaft 511 and the pushing member 52 may be screw connection or adhesion.

Referring to FIGS. 6 and 7, in one embodiment, the first end 53a of the transmission member 53 has a mounting base 533 connected to the pushing member 52. One side of the mounting base 533 is protruded with a guide post 534. A linear guide groove 11 extending along a direction parallel to the output shaft 511 of the linear actuator 51 is defined in a side surface of the base member 10, and the guide post 534 is slidably received in the linear guide groove 11. By the engagement of the guide post 523 with the linear guide groove 11, it can realize the forward and backward movement of the transmission member 53 in a predetermined direction, thereby improving the reliability of the mechanism. One end of the pushing member 52 can be connected to the first end 53a of the transmission member 53 by a ball joint, which facilitates the assembly of the transmission member 53 to the pushing member 52 and reduces the difficulty of assembly. In addition, it facilitates power transmission, so that the pushing member 52 and the transmission member 53 can drive each other to move.

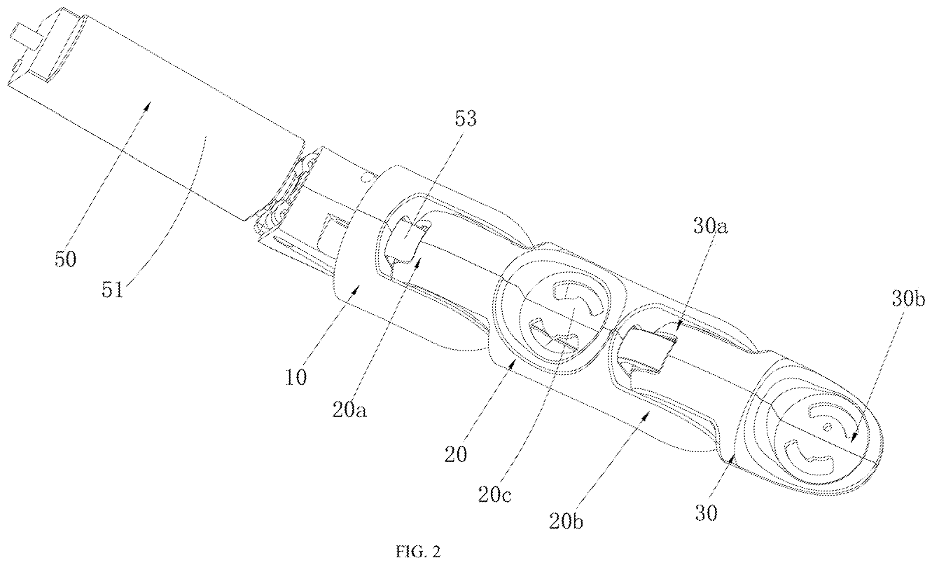

Referring to FIGS. 2 and 3, in one embodiment, the first link 20 has two first connecting walls 24 spaced apart from each other, and a first space 241 is formed between the two first connecting walls 24. One end of the second link 30 is received the first space 241, and pivotally connected to the first connecting walls 24. In this way, one end of the second link 30 can be reliably pivotally connected to the first link 20.

Referring to FIGS. 2 and 3, in one embodiment, the inner surface of each first connecting wall 24 is provided with a first pivot hole 242, and each of the two opposite sides of the second link 30 is provided with a first pivot shaft 31. The first pivot shafts 31 are supported in the first pivot holes 242 through bearings (not shown). The bearings can reduce the frictional force between the first pivot shafts 31 and the inner surface of the first pivot holes 242, so that the first pivot shafts 31 and the first pivot holes 242 are reliably connected to each other. As a result, one end of the second link 30 is reliably pivotally connected to the first link 20.

Referring to FIGS. 3, 5, and 6, in one embodiment, the elastic member 60 is a torsion spring, and the inner surface of one of the first connecting walls 24 is provided with a first positioning groove 243. The outer surface of the second link 30 is provided with a second positioning groove 32. One portion of the torsion spring is disposed in the first positioning groove 243, and the other portion is disposed in the second positioning groove 32. The two arms 62 of the torsion spring are respectively disposed against the one of the first connecting walls 24 and the second link 30. In this way, it can fix the torsion spring between the first link 20 and the second link 30, making full use of the axial space and making the structure compact. The first positioning groove 243 can position a portion of the helical part 61 and one torsion arm 62 of the torsion spring, and the second positioning groove 32 can position a portion of the helical part 61 and the other torsion arm 62 of the torsion spring. The two arms 62 can pass through the one of the first connecting walls 24 and the second link 30, respectively, so as to realize the fixing of the arms 62.

Referring to FIGS. 1 and 3, in one embodiment, the base member 10 has two second connecting walls 13 spaced apart from each other, and a second space 131 is formed between the two second connecting walls 13. The first end 20a of the first link 20 is received in the second space 131, and pivotally connected to the second connecting walls 13. In this way, the first end 20a of the first link 20 can be reliably pivotally connected to the base member 10.

Referring to FIG. 3, in one embodiment, the inner surface of each second connecting wall 13 is provided with a second pivot hole 132, and each of the two opposite sides of the first link 20 is provided with a second pivot shaft 25. The second pivot shafts 25 are supported in the second pivot holes 132 through bearings (not shown). The bearings can reduce the friction force between the second pivot shafts 25 and the inner surfaces of the second pivot holes 132, so that the second pivot shafts 25 and the second pivot holes 132 are reliably connected to each other, and the first end 20a of the first link 20 is reliably pivotally connected to the base member 10.

Referring to FIGS. 6 and 7, in one embodiment, the first link 20 is provided with an arc-shaped guide groove 26, and the arc-shaped guide groove 26 is centered on the pivot axis 102 about which the first link 20 rotate relative to the base member 10. One end of the connecting member 40 has a pivot shaft 41 that passes through the arc-shaped guide groove 26. One end of the pivot shaft 41 is pivotally connected to one second connecting wall 13. For example, as shown in FIG. 3, one end of the pivot shaft 41 is inserted into the pivot hole 133 of one second connecting wall 13. The axis of the pivot shaft 41 is the pivot axis 101 about which the connecting member 40 rotates relative to the base member 10. The pivot shaft 41 passes through the first link 20 and is connected to the base member 10, and then the connecting member 40 is pivotally connected to the base member 10. The end of the pivot shaft 41 can be supported on the second connecting wall 13 through a bearing (not shown), which can reduce the friction between the pivot shaft 41 and the second connecting wall 13. Thus, the connecting rod 40 is reliably pivotally connected to the second connecting wall 13.

Referring to FIGS. 6 and 7, in one embodiment, the connecting member 40 includes a first bent portion 42, and the concave side 421 of the first bent portion 42 faces the outer side 20d of the first link 20. One end of the first bent portion 42 is pivotally connected to the second link 30. The connecting member 40 further includes a second bent portion 43 connected to one end of the first bent portion 42, and the concave side 431 of the second bent portion 43 faces the inner side 20c of the first link 20. One end of the second bent portion 43 is pivotally connected to the base member 10. The bent portions can be understood as bent structures with concave sides formed by bending rods. The bent portions are roughly 7-shaped or T-shaped, and the specific shaping method is not limited. The connecting member 40 is formed to include the first bent portion 42 and the second bent portion 43. The concave side 421 of the first bent portion 42 and the concave side 431 of the second bent portion 43 face different directions. The first bent portion 42 and the second bent portion 43 are approximately in a single-cycle sinusoidal structure, which can improve the elasticity of the connecting member 40 to absorb the external impact, and allow the second link 30 to immediately return to the original state when the external impact disappears.

In one embodiment, a robotic finger includes the linkage mechanism discussed above. Specifically, the base member 10 is to function as a proximal phalanx, the first link 20 is to function as a middle phalanx, and the second link 30 is to function as a distal phalanx. The base member 10, the first link 20 and the second link 30 are arranged in sequence. Since the robotic finger includes all the features discussed above, it has all the beneficial effects brought by the features discussed above, which will not be repeated here.

In one embodiment, a robot includes the linkage mechanism discussed above. Since the robot includes all the features discussed above, it has all the beneficial effects brought by the features discussed above, which will not be repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A linkage mechanism comprising:
a base member;
a first link having a first end and an opposite, second end, the first end rotatably connected to the base member;
a second link rotatably connected to the second end of the first link;
a connecting member having two opposite ends rotatably connected to the base member and the second link;
an actuating mechanism comprising a linear actuator comprising an output shaft, a pushing member, and a transmission member, the pushing member connected to and slidable along the output shaft, the pushing member comprising a pushing surface that is configured to be pushed by the output shaft, the transmission member comprising a first end hinged to the pushing member, and an opposite second end pivoted to the first end of the first link, wherein a first pivot axis about which the transmission member rotates relative to the first link and a second pivot axis about which the first link rotates relative to the base member are spaced apart from each other; and
an elastic member connected to the first link and the second link, the elastic member configured to drive the second link to an original position of the second link;
wherein when the output shaft extends and moves to push the pushing surface, the pushing member moves and the first link rotates relative to the base member.

2. The linkage mechanism of claim 1, wherein the output shaft is hollow, the pushing member is slidably received in the output shaft, one end of the pushing member comprises a head, and the pushing surface is formed on the head; or the pushing member is hollow, the pushing member is arranged around the output shaft, one end of the pushing member comprises a head, and the pushing surface is formed on the head.

3. The linkage mechanism of claim 1, wherein the first link defines a chamber, the first end of the first link defines a first opening in communication with the chamber, the transmission member passes through the first opening; the transmission member comprises a first bending arm having a concave side facing an outside of the base member, and one end of the first bending arm is pivotally connected to the first link; the transmission member further comprises a second bending arm connected to the first bending arm and having a concave side facing an inner side of the base member, one end of the second bending arm is fixed to the output shaft of the linear actuator.

4. The linkage mechanism of claim 1, wherein the pushing member is detachably connected to the output shaft.

5. The linkage mechanism of claim 1, wherein the first end of the transmission member comprises a mounting base connected to the pushing member, and a guide post protrudes from the mounting base, the base defines a linear guide groove extending along a direction parallel to the output shaft of the linear actuator, and the guide post is slidably received in the linear guide groove.

6. The linkage mechanism of claim 1, wherein the first link comprises two first connecting walls spaced apart from each other, a first space is formed between the two first connecting walls, one end of the second link is received in the first space, and rotatably connected to the first connecting walls.

7. The linkage mechanism of claim 6, wherein the elastic member is a torsion spring, one of the first connecting walls defines a first positioning groove, an outer surface of the second link defines a second positioning groove, the elastic member is partly received in the first positioning groove and the second positioning groove, and is abutted against the one of the first connecting walls and the second link.

8. The linkage mechanism of claim 1, wherein the base member comprises two second connecting walls spaced apart from each other, a second space is formed between the two second connecting walls, and the first end of the first link is received in the second space, and rotatably connected to the second connecting walls.

9. The linkage mechanism of claim 8, wherein the first link defines an arc-shaped guide groove that is centered on the pivot axis about which the first link rotates relative to the base member, one end of the connecting member comprises a pivot shaft that passes through the arc-shaped guide groove, and one end of the pivot shaft is rotatably connected to one of the second connecting walls.

10. The linkage mechanism of claim 1, wherein the connecting member comprises a first bent portion, and a concave side of the first bent portion faces an external surface of the first link, one end of the first bent portion is pivotally connected to the second link, the connecting member further comprises a second bent portion connected to one end of the first bent portion, a concave side of the second bent portion faces an inner surfaced of the first link, and one end of the second bent portion is pivotally connected to the base member.

11. The linkage mechanism of claim 1, wherein the first link defines a chamber, at least a portion of the connecting member is accommodated in the first link, the second end of the first link defines a second opening communicating with the chamber, and the connecting member passes through the second opening.

12. A robotic finger comprising:
a base member;
a first link having a first end and an opposite, second end, the first end rotatably connected to the base member;
a second link rotatably connected to the second end of the first link;
a connecting member having two opposite ends rotatably connected to the base member and the second link;
an actuating mechanism comprising a linear actuator comprising an output shaft, a pushing member, and a transmission member, the pushing member connected to and slidable along the output shaft, the pushing member comprising a pushing surface that is configured to be pushed by the output shaft, the transmission member comprising a first end hinged to the pushing member, and an opposite second end pivoted to the first end of the first link, wherein a first pivot axis about which the transmission member rotates relative to the first link and a second pivot axis about which the first link rotates relative to the base member are spaced apart from each other; and
an elastic member connected to the first link and the second link, the elastic member configured to drive the second link to an original position of the second link;
wherein when the output shaft extends and moves to push the pushing surface, the pushing member moves and the first link rotates relative to the base member;
wherein the base member is configured to function as a proximal phalanx, the first link is configured to function as a middle phalanx, and the second link is configured to function as the distal phalanx.

13. The robotic finger of claim 12, wherein the output shaft is hollow, the pushing member is slidably received in the output shaft, one end of the pushing member comprises a head, and the pushing surface is formed on the head; or the pushing member is hollow, the pushing member is arranged around the output shaft, one end of the pushing member comprises a head, and the pushing surface is formed on the head.

14. The robotic finger of claim 12, wherein the first link defines a chamber, the first end of the first link defines a first opening in communication with the chamber, the transmission member passes through the first opening; the transmission member comprises a first bending arm having a concave side facing an outside of the base member, and one end of the first bending arm is pivotally connected to the first link; the transmission member further comprises a second bending arm connected to the first bending arm and having a concave side facing an inner side of the base member, one end of the second bending arm is fixed to the output shaft of the linear actuator.

15. The robotic finger of claim 12, wherein the pushing member is detachably connected to the output shaft.

16. The robotic finger of claim 12, wherein the first end of the transmission member comprises a mounting base connected to the pushing member, and a guide post protrudes from the mounting base, the base defines a linear guide groove extending along a direction parallel to the output shaft of the linear actuator, and the guide post is slidably received in the linear guide groove.

17. The robotic finger of claim 12, wherein the first link comprises two first connecting walls spaced apart from each other, a first space is formed between the two first connecting walls, one end of the second link is received in the first space, and rotatably connected to the first connecting walls.

18. The robotic finger of claim 17, wherein the elastic member is a torsion spring, one of the first connecting walls defines a first positioning groove, an outer surface of the second link defines a second positioning groove, the elastic member is partly received in the first positioning groove and the second positioning groove, and is abutted against the one of the first connecting walls and the second link.

19. The robotic finger of claim 12, wherein the base member comprises two second connecting walls spaced apart from each other, a second space is formed between the two second connecting walls, and the first end of the first link is received in the second space, and rotatably connected to the second connecting walls.

20. A robot comprising:
a robotic finger comprising:
a base member;
a first link having a first end and an opposite, second end, the first end rotatably connected to the base member;
a second link rotatably connected to the second end of the first link;
a connecting member having two opposite ends rotatably connected to the base member and the second link;
an actuating mechanism comprising a linear actuator comprising an output shaft, a pushing member, and a transmission member, the pushing member connected to and slidable along the output shaft, the pushing member comprising a pushing surface that is configured to be pushed by the output shaft, the transmission member comprising a first end hinged to the pushing member, and an opposite second end pivoted to the first end of the first link, wherein a first pivot axis about which the transmission member rotates relative to the first link and a second pivot axis about which the first link rotates relative to the base member are spaced apart from each other; and
an elastic member connected to the first link and the second link, the elastic member configured to drive the second link to an original position of the second link;
wherein when the output shaft extends and moves to push the pushing surface, the pushing member moves and the first link rotates relative to the base member;
wherein the base member is configured to function as a proximal phalanx, the first link is configured to function as a middle phalanx, and the second link is configured to function as the distal phalanx.
